(19) United States
(12) Patent Application Publication
(10) Pub. No.: US 2022/0237828 A1
(43) Pub. Date: Jul. 28, 2022

(54) INFORMATION PRESENTATION APPARATUS, METHOD, AND PROGRAM

(71) Applicant: Nippon Telegraph and Telephone Corporation, Tokyo (JP)

(72) Inventors: Masaya Tamaru, Musashino-shi, Tokyo (JP); Shinichiro Eitoku, Musashino-shi, Tokyo (JP); Akira Suzuki, Musashino-shi, Tokyo (JP)

(21) Appl. No.: 17/611,960

(22) PCT Filed: Jun. 12, 2019
(86) PCT No.: PCT/JP2019/023352

§ 371 Date: Nov. 17, 2021

(51) Int. Cl. G06T 11/00; G06T 7/11; G06T 7/70

(52) U.S. Cl. CPC G06T 11/00; G06T 7/70; G06T 7/11

(57) ABSTRACT

An information presentation apparatus according to an embodiment includes a processor, the processor being configured to perform first extraction processing to extract a region in which an object is displayed on a display screen on which an image is displayed, perform second extraction processing to extract a plurality of display candidate regions that are candidates for a region in which synthesized information to be synthesized with the image is displayed from regions other than the region extracted by the first extraction processing on the display screen, perform selection processing to select an optimum one of the regions extracted by the second extraction processing as a region in which the synthesized information is displayed on the display screen, and perform display processing to display the synthesized information in the region selected by the selection on the display screen.

### TECHNICAL FIELD

An embodiment of the present invention relates to an information presentation apparatus, a method, and a program.

### BACKGROUND ART

A method in which additional information such as character information is overlapped on a screen on which an original image is displayed to perform image synthesis has been generally used and has been used not only in TV broadcasting but also in Internet moving-image distribution services. In recent years, an AR (Augmented Reality) technology to overlap information with an actual background rather than an image using a transparent display has become pervasive.

Conventionally, there has been known a technology to adjust the color of synthesized information as a technology to improve the visibility of additional information that is to be synthesized with an original image (see, for example, Non-Patent Literature 1).

### CITATION LIST

### Non Patent Literature

[NPL 1] SmartColor: Real-Time Color Correction and Contrast for Optical See-Through Head-Mounted Displays:
http://hci.cs.umanitoba.ca/publications/details/smartcolor-real-time-color-correction-and-contrast-for-optical-see- through

### SUMMARY OF THE INVENTION

### Technical Problem

When additional information is synthesized with an original image or when the additional information is synthesized with an actual background over a transparent display, an object to which a user originally wants to refer may be hidden by the additional information since a part or the whole of the object to which the user wants to refer on a screen and the additional information additionally overlapped with the original image are overlapped with each other. Therefore, there is a case that the visibility of a part or the whole of the object to which the user wants to refer and a part or the whole of the additional information reduces.

Therefore, the display position of additional information is required to be appropriately set by hand according to the emergence of an object to which the user wants to refer. As a result, a burden on the user increases.

The present invention has been made in view of the above circumstances and has an object of providing an information presentation apparatus, a method, and a program that make it possible to realize the appropriate visibility of an object on an image display screen and the appropriate visibility of information synthesized with the image.

### Means for Solving the Problem

In order to achieve the above object, an information presentation apparatus according to an aspect of the present invention includes a processor, the processor being configured to perform first extraction processing to extract a region in which an object is displayed on a display screen on which an image is displayed, perform second extraction processing to extract a plurality of display candidate regions that are candidates for a region in which synthesized information to be synthesized with the image is displayed from regions other than the region extracted by the first extraction processing on the display screen, perform selection processing to select an optimum one of the regions extracted by the second extraction processing as a region in which the synthesized information is displayed on the display screen, and perform display processing to display the synthesized information in the region selected by the selection processing on the display screen.

An information presentation method performed by an information presentation apparatus according to an aspect of the present invention is an information presentation method performed by an information presentation apparatus including a processor, the information presentation method including: performing, by the processor, first extraction processing to extract a region in which an object is displayed on a display screen on which an image is displayed; performing, by the processor, second extraction processing to extract a plurality of display candidate regions that are candidates for a region in which synthesized information to be synthesized with the image is displayed from regions other than the region extracted by the first extraction processing on the display screen; performing, by the processor, selection processing to select an optimum one of the regions extracted by the second extraction processing as a region in which the synthesized information is displayed on the display screen; and performing, by the processor, display processing to display the synthesized information in the region selected by the selection processing on the display screen.

### Effects of the Invention

According to the present invention, the appropriate visibility of an object on an image display screen and the appropriate visibility of information synthesized with the image can be realized.

### BRIEF DESCRIPTION OF DRAWINGS

FIG. 1 is a diagram showing an application example of an information presentation apparatus according to an embodiment of the present invention.

FIG. 2 is a diagram showing an example of the hardware configuration of the information presentation apparatus.

FIG. 3 is a flowchart showing an example of a processing operation by the information presentation apparatus according to an embodiment of the present invention.

FIG. 4 is a diagram showing an example of an input original image and objects.

FIG. 5 is a diagram showing an example of a synthesized information displayable region.

FIG. 6 is a diagram showing an example of synthesized information display candidate regions.

FIG. 7 is a diagram showing an example of the extraction of a synthesized information display region.

FIG. 8 is a diagram showing an example of modification relating to a synthesized information display candidate region.

FIG. 9 is a diagram showing an example of the update of synthesized information display candidate regions with the movement of the positions of objects on a screen.

FIG. 10 is a diagram showing an example of synthesized information display candidate regions before the movement of the objects on the screen.

FIG. 11 is a diagram showing an example of updated synthesized information display candidate regions after the movement of the objects on the screen.

FIG. 12 is a diagram showing an example of a region having the greatest area among the updated synthesized information display candidate regions.

### DESCRIPTION OF EMBODIMENTS

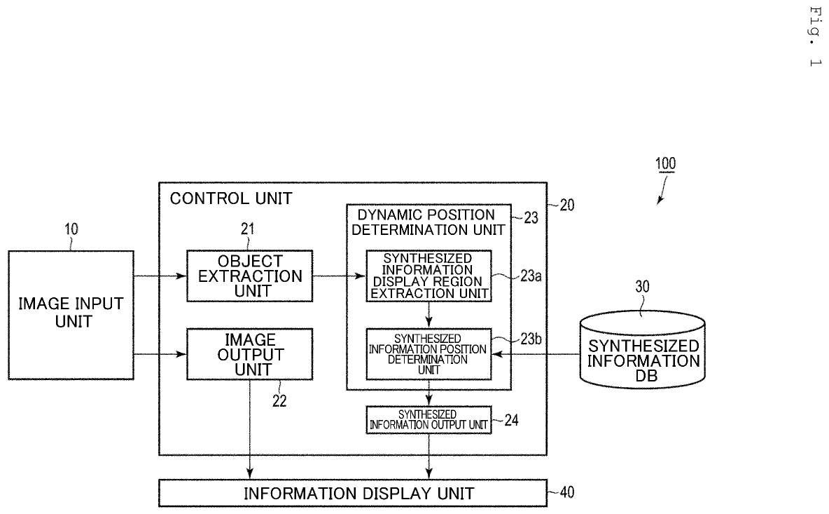

Hereinafter, an embodiment according to the present invention will be described with reference to the drawings. FIG. 1 is a diagram showing an application example of an information presentation apparatus according to an embodiment of the present invention.

As shown in FIG. 1, an information presentation apparatus 100 has an image input unit 10, a control unit 20, a synthesized information database (DB) 30, and an information display unit 40. The control unit 20 has an object extraction unit 21, an image output unit 22, a dynamic position determination unit 23, and a synthesized information output unit 24.

The dynamic position determination unit 23 has a synthesized information display region extraction unit 23a and a synthesized information position determination unit 23b.

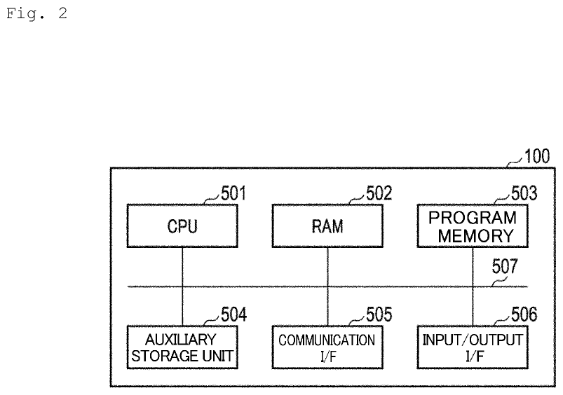

FIG. 2 is a diagram showing an example of the hardware configuration of the information presentation apparatus 100.

As shown in FIG. 2, the information presentation apparatus 100 includes a CPU (Central Processing Unit) 501, a RAM (Random Access Memory) 502, a program memory 503, an auxiliary storage unit 504, a communication interface 505, an input/output interface 506, and a bus 507 as hardware. The CPU 501 communicates with the RAM 502, the program memory 503, the auxiliary storage unit 504, the communication interface 505, and the input/output interface 506 via the bus 507.

The CPU 501 is an example of a general-purpose hardware processor. The RAM 502 is used by the CPU 501 as a working memory. The RAM 502 contains a non-volatile memory such as a SDRAM (Synchronous Dynamic Random Access Memory). The program memory 503 stores various programs containing a processing program by the control unit 20. As the program memory 503, a ROM (Read-Only Memory), a part of the auxiliary storage unit 504, or a combination of the ROM and the auxiliary storage unit 504 is, for example, used. The auxiliary storage unit 504 stores data in a non-transitory manner. The auxiliary storage unit 504 contains a non-volatile memory such as a hard disk drive (HDD) and a solid-state drive (SSD). The auxiliary storage unit 504 stores various data in processing by the control unit 20.

The communication interface 505 is an interface for communication with an external communication apparatus. The communication interface 505 includes, for example, a wired LAN terminal and is connected by a LAN cable to a communication network that can contain the Internet. The input/output interface 506 includes a plurality of terminals for connection with an input apparatus and an output apparatus. Examples of the input apparatus include a keyboard, a mouse, and a microphone. Examples of the output apparatus include a display apparatus and a speaker.

Respective programs stored in the program memory 503 contain a computer-executable instruction. When executed by the CPU 501, a program (computer-executable instruction) causes the CPU 501 to execute prescribed processing. For example, when executed by the CPU 501, a program that realizes the functions of the respective units inside the information presentation apparatus 100 causes the CPU 501 to execute a series of processing described in association with the respective units inside the information presentation apparatus 100.

A program may be supplied to the information presentation apparatus 100 in a state of being stored in a computer-readable storage medium. In this case, for example, the information presentation apparatus 100 further includes a drive (not shown) that reads data from the storage medium and acquires the program from the storage medium. Examples of the storage medium include a magnetic disk, an optical disk (such as a CD-ROM, a CD-R, a DVD-ROM, and a DVD-R), a magnetic optical disk (such as a MO), and a semiconductor memory. Further, a program may be stored in a server on a communication network so that the information presentation apparatus 100 downloads the program from the server using the communication interface 505.

Processing described in an embodiment is not necessarily performed when a general-purpose processor such as the CPU 501 performs a program but may be performed by a dedicated processor such as an ASIC (Application Specific Integrated Circuit). In an example shown in FIG. 2, a processing circuitry is realizable using the CPU 501, the RAM 502, and the program memory 503. The processing circuitry contains at least one general-purpose hardware processor, at least one dedicated hardware processor, or a combination of at least one general-purpose hardware processor and at least one dedicated hardware processor. Further, the image input unit 10 and the information display unit 40 are realizable using the input/output interface 506, and the synthesized information database (DB) 30 is realizable using the auxiliary storage unit 504.

Note that the information presentation apparatus 100 is not necessarily implemented by one computer (information processing apparatus). The information presentation apparatus 100 may be implemented by a plurality of computers. For example, the information presentation apparatus 100 may be constituted by a computer that functions as the image input unit 10 and the control unit 20 and a computer that functions as the synthesized information database (DB) 30 and the information display unit 40.

FIG. 3 is a flowchart showing an example of a processing operation by the information presentation apparatus according to an embodiment of the present invention.

In the processing operation, it is assumed that the image output unit 22 of the control unit 20 outputs an original image containing an initial object to the information display unit 40 and the image is displayed on a screen by the information display unit 40 when the information presentation apparatus starts for the first time.

The image input unit 10 of the information presentation apparatus 100 inputs an original image from an outside (S11).

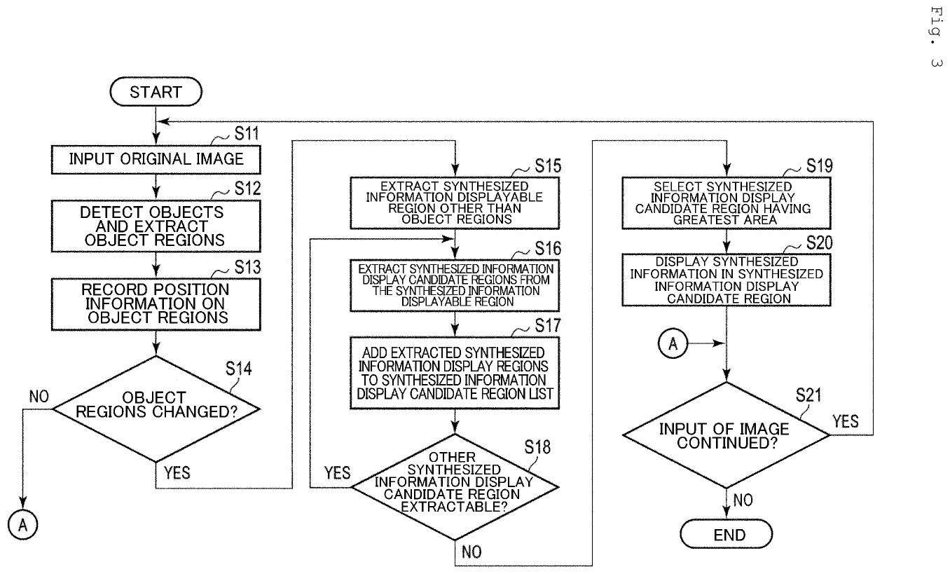

FIG. 4 is a diagram showing an example of an input original image and objects.

In the example shown in FIG. 4, a slightly horizontally-oriented elliptical object A-1 is displayed near the upper left part of the screen of the original image that has been input by the image input unit 10, a vertically-oriented elliptical object A-2 is displayed near the central part of the screen of the original image, and an object B-1 showing numbers “01234567890” is displayed at the lower part of the screen of the original image.

Next, the object extraction unit 21 of the control unit 20 detects one or a plurality of objects displayed in the original image from the original image. Then, the object extraction unit 21 extracts object regions that are regions occupied by the objects, for example, the objects A-1, A-2, and B-1 shown in FIG. 4 in the screen of the original image (S12).

The object extraction unit 21 records information on coordinates showing the extracted object regions on an internal memory (S13).

When the recorded coordinates of the regions occupied by the objects are changed, that is, when the positions of the objects on the screen are moved, the object themselves are changed, or new objects are added (YES in S14), the synthesized information display region extraction unit 23a of the dynamic position determination unit 23 extracts, from all the regions of the original image on the screen, a region other than the regions shown by the objects as a synthesized information displayable region that is a region in which synthesized information that is information to be synthesized with (added to) the original image is displayable, and records the coordinates of the synthesized information displayable region on the internal memory (S15). The synthesized information displayable region is an outline candidate for the display destination of actual synthesized information, and the display destination of the actual synthesized information is a region narrowed down from the synthesized information displayable region.

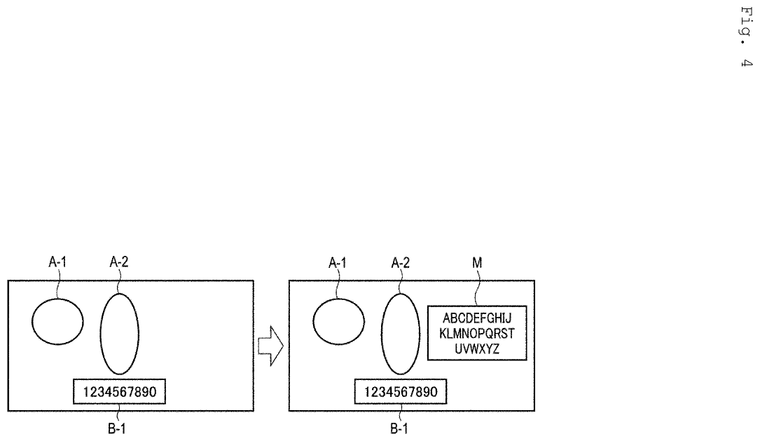

FIG. 5 is a diagram showing an example of a synthesized information displayable region.

In an example shown in FIG. 5, a region r other than regions shown by objects A-1, A-2, and B-1 among all the regions of an original image is a synthesized information displayable region. The synthesized information display region extraction unit 23a extracts synthesized information display candidate regions that are candidates for a region in which the synthesized information is to be displayed from the synthesized information displayable region extracted in S15 (S16).

As a specific example of S16, the synthesized information display region extraction unit 23a extracts regions that are surrounded by two lines parallel to an x-axis and not crossing the objects and two lines parallel to a y-axis and not crossing the objects and that form rectangles or squares not containing the regions shown by the objects in a synthesized information displayable region as synthesized information display candidate regions.

In the present embodiment, in order to extract appropriate regions as candidates for the display destination of actual synthesized information, regions that satisfy at least one of various conditions such as a condition that the regions have an area of a certain level or more, a condition that the regions are not sandwiched between objects, and a condition that the regions are in contact with any edge on a screen may be extracted as synthesized information display candidate regions. Further, when a plurality of synthesized information display candidate regions that satisfy the above conditions are partially overlapped with each other on the screen, only a region having a greater area among the regions may be extracted as a synthesized information display candidate region.

The synthesized information display region extraction unit 23a adds the coordinates of the extracted synthesized information display candidate regions to a synthesized information display candidate region list in which the initial state of the coordinates is 0 (S17). The list is recorded on the internal memory of the synthesized information display region extraction unit 23a.

When other synthesized information display candidates are extractable from the synthesized information displayable region, that is, when any synthesized information display candidate that has not been extracted from the synthesized information displayable region exists (YES in S18) after S17, the synthesized information display region extraction unit 23a performs the processing after S16 again. Thus, other synthesized information display candidates are extracted.

FIG. 6 is a diagram showing an example of synthesized information display candidate regions.

In the example shown in FIG. 6, the following six regions C₁ to C₆ are extracted as synthesized information display candidate regions when the processing of S16 and the processing of S17 are performed a plurality of times.

(1) The horizontally-oriented rectangular region C₁ that is in contact with the upper left corner, the upper side, and the left side of a synthesized information displayable region, the upper end of the object A-1, and an end near the upper left part of the object A-2

(2) The vertically-oriented rectangular region C₂ that is in contact with the upper left and lower left corners, the left side, the upper side, and the lower side of the synthesized information displayable region and the left end of the object A-1

(3) The horizontally-oriented rectangular region C₃ that is in contact with the left side of the synthesized information displayable region, the lower end of the object A-1, and an end near the lower left part of the object A-2

(4) The square region C₄ that is in contact with the upper right corner, the upper side, and the right side of the synthesized information displayable region, the right end of the object A-2, the upper side of the object B-1, and the upper right corner of the object B-1

(5) The square region C₅ that is in contact with the lower left corner, the left side, and the lower side of the synthesized information displayable region, the lower end of the object A-1, and a part near the left end of the object B-1

(6) The vertically-oriented rectangular region C₆ that is in contact with the upper right and lower right corners, the upper side, the lower side, and the right side of the synthesized information displayable region and a part near the right end of the object B-1

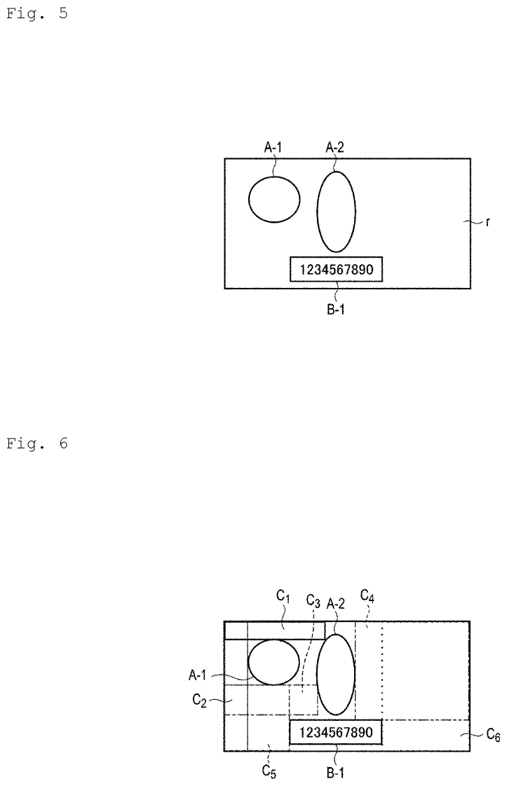

FIG. 7 is a diagram showing an example of the extraction of a synthesized information display region.

Next, the synthesized information position determination unit 23b selects a region having the greatest area among the synthesized information display candidate regions extracted as described above from the synthesized information display candidate region list as a synthesized information display region that is a final and optimum region on which the synthesized information is to be actually displayed (S19). The synthesized information display region is not limited to a region having the greatest area, but a region closest to a prescribed position among the extracted synthesized information display candidate regions or the like may be, for example, selected.

In the example shown in FIG. 7, areas Sᵢ of regions Cᵢ are defined as follows when the lower left coordinates, the lower right coordinates, the upper left coordinates, and the upper right coordinates of the regions Cᵢ (i=1, . . . , 6) are expressed as (xᵢ₁, yᵢ₂), (xᵢ₂, yᵢ₂), (xᵢ₁, yᵢ₁), and (xᵢ₂, yᵢ₁), respectively, in the regions C₁ to C₆.

Sᵢ=(xᵢ₂−xᵢ₂)′(yᵢ₁−yᵢ₂) Formula (1)

Among the regions, the synthesized information position determination unit 23b selects a region Cᵢ having the greatest area Sᵢ (the region C₄ in FIG. 7) as a synthesized information display region.

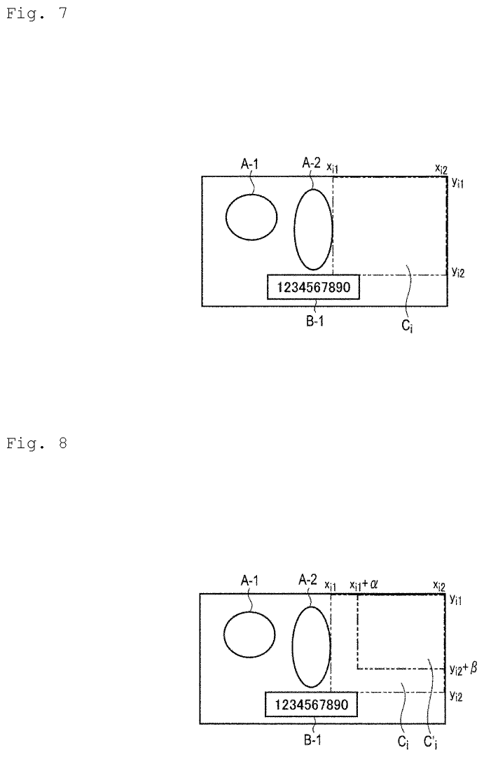

FIG. 8 is a diagram showing an example of modification relating to a synthesized information display candidate region.

Here, prior to the selection in S19, in order to make the objects and the synthesized information positioned separately from each other by a certain distance on the screen, the synthesized information position determination unit 23b may modify coordinates in an x-axis direction of sides so that the positions of the sides that are sides in a y-axis direction and are in contact with the objects among the respective sides of the synthesized information display candidate regions shown in the synthesized information display candidate region list are modified into positions on the inside of the regions separated from the objects.

Similarly, the synthesized information position determination unit 23b may modify coordinates in the y-axis direction of sides so that the positions of the sides that are sides in the x-axis direction and are in contact with the objects among the respective sides of the synthesized information display candidate regions shown in the synthesized information display candidate region list are modified into positions on the inside of the regions.

The modification of the coordinates of respective sides is made for each of the synthesized information display candidate regions shown in the synthesized information display candidate region list.

In the example shown in FIG. 8, as for a region Cᵢ that is a synthesized information display candidate region to be modified, a coordinate in an x-axis direction of a side that is a side in a y-axis direction and is in contact with an object is modified from xᵢ₁ to xᵢ₁+α, and a coordinate in the y-axis direction that is a side in the x-axis direction and is in contact with an object is modified from yᵢ₂ to yᵢ₂+β.

By the modification, the region Cᵢ before the modification is modified into a region C′ᵢ smaller than the region Cᵢ.

In the processing of S19 after the modification of coordinates in the manner described above, a region having the greatest area among the respective areas of the respective synthesized information display candidate regions expressed by coordinates after the modification is selected from among the synthesized information display candidates.

The synthesized information position determination unit 23b outputs the synthesized information stored in the synthesized information database 30 to the synthesized information output unit 24 together with information showing the region selected in S19. The synthesized information output unit 24 causes the synthesized information to be displayed at a position corresponding to the region selected in S19 on the screen of the original image displayed by the information display unit 40 (S20).

Here, at the position corresponding to the region selected in S19 on the screen of the original image, synthesized information M showing character information “ABCDEFGHIJKLMNOPQUSTUVWXYZ” shown in FIG. 4 or the like can be displayed.

In the display of synthesized information, the synthesized information output unit 24 may modify the size of the synthesized information into a size smaller than a prescribed standard size so that the size of the synthesized information falls within the size of the region selected in S19.

If the input of an original image is continued (YES in S21) after S20 or when the recorded coordinates of the regions occupied by the objects are not changed (NO in S14), the processing returns to S11, and if the input of an original image is not continued (NO in S21), a series of the processing ends.

Next, the update of a synthesized information display candidate region list with the movement of the positions of objects on the screen will be described. FIG. 9 is a diagram showing an example of the update of synthesized information display candidate regions with the movement of the positions of objects on the screen.

A case in which the positions of objects are moved in a state in which the objects A-1, A-2, and B-1 and the synthesized information M are displayed on the screen will be described. As shown in, for example, FIG. 9, when the objects A-1 and A-2 positioned on the left side of the screen are moved to the right side of the screen, the position of the synthesized information is required to be moved so that the respective objects containing the moved objects and the synthesized information positioned on the right side of the screen are not overlapped with each other on the screen. Therefore, the synthesized information position determination unit 23b dynamically updates a synthesized information display candidate region list.

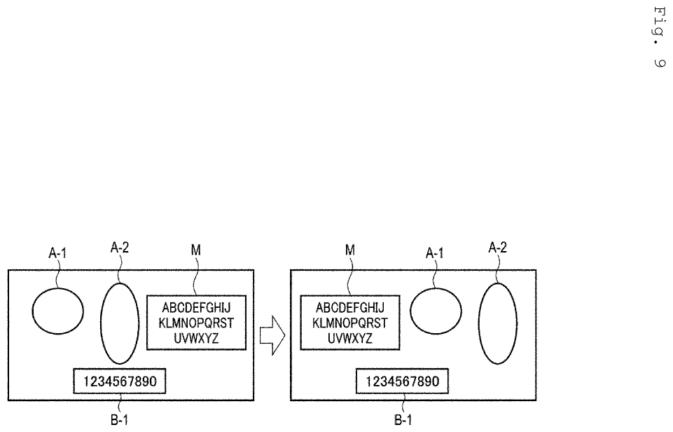

FIG. 10 is a diagram showing an example of synthesized information display candidate regions before the movement of objects on the screen. In the example shown in FIG. 10, it is assumed that the regions C₁, C₄, and C₅ shown in FIG. 6 are extracted as synthesized information display candidate regions before the movement of the objects on the screen.

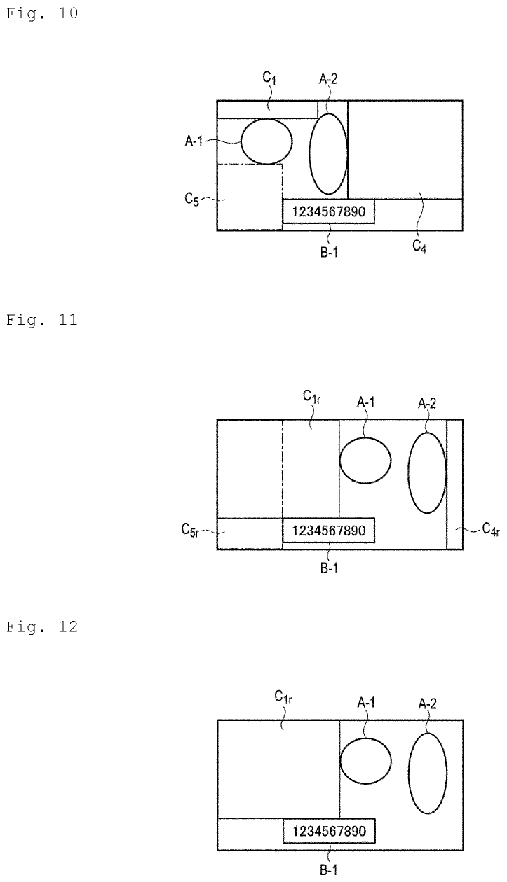

FIG. 11 is a diagram showing an example of updated synthesized information display candidate regions after the movement of objects on the screen.

In the example shown in FIG. 11, when the objects A-1 and A-2 positioned on the left side of the screen are moved to the right side of the screen, the synthesized information display region extraction unit 23a newly extracts the coordinates of synthesized information display candidate regions shown in the synthesized information display candidate region list, that is, synthesized information display candidate regions, for example, regions C₁ᵣ, C₄ᵣ, and C₅ᵣ, shown in FIG. 11 so that the regions are not overlapped with the regions of the objects after the movement. Thus, the synthesized information display candidate regions are updated.

The region C₁ᵣ shown in FIG. 11 is a region updated from the region C₁ shown in FIG. 10 and is a slightly horizontally-oriented rectangular region that is in contact with the upper left part, the upper left corner, the upper side, and the left side of the synthesized information display candidate region, the left end of the object A-1 after the movement, and the upper side and the upper left corner of the object B-1.

The region C₄ᵣ shown in FIG. 11 is a region updated from the region C₄ shown in FIG. 10 and is a vertically-oriented rectangular region that is in contact with the upper right and lower right corners, the upper side, the lower side, and the right side of the synthesized information displayable region and the right end of the object A-2 after the movement.

The region C₅ᵣ shown in FIG. 11 is a region updated from the region C₅ shown in FIG. 10 and is a vertically-oriented rectangular region that is in contact with the upper left and lower left corners, the upper side, the lower side, and the left side of the synthesized information display candidate region and a part near the left end of the object B-1.

FIG. 12 is a diagram showing an example of a synthesized information display candidate region having the greatest area among updated synthesized information display candidate regions.

In the example shown in FIG. 12, the region C₁ᵣ having the greatest area among the updated synthesized information display candidate regions C₁ᵣ, C₄ᵣ, and C₅ᵣ is selected as a new synthesized information display region by the synthesized information position determination unit 23b .

Thus, even if the positions of objects on the screen are moved, a synthesized information display region is updated to an appropriate region.

As described above, the information presentation apparatus according to an embodiment of the present invention makes it possible to display synthesized information that is to be synthesized with an original image so as not to be overlapped with objects displayed on a screen.

Further, the information presentation apparatus according to an embodiment of the present invention makes it possible to dynamically determine a region in which synthesized information is to be displayed according to the regions of objects in an original image and is therefore not required to statically set the display position of the synthesized information in advance.

Accordingly, each of an improvement in the visibility of synthesized information and an improvement in the visibility of objects displayed in an original image can be realized in the present embodiment.

Note that the present invention is not limited to the above embodiments and may be deformed in various ways without departing from the gist in its execution stage. Further, the respective embodiments may be appropriately combined together as much as possible to be performed. In this case, combined effects are produced, and in addition, the above embodiments include the inventions of various stages, and various inventions can be extracted when a plurality of disclosed constituting elements are appropriately combined together.

### REFERENCE SIGNS LIST

10 Image input unit
20 Control unit
21 Object extraction unit
22 Image output unit
23 Dynamic position determination unit
23a Synthesized information display region extraction unit
23b Synthesized information position determination unit
24 Synthesized information output unit
30 Synthesized information database
40 Information display unit
100 Information presentation apparatus
501 CPU
502 RAM
503 Program memory
504 Auxiliary storage unit
505 Communication interface
506 Input/output interface
507 Bus

1. An information presentation apparatus comprising:
a processor,
the processor being configured to
perform first extraction processing to extract a region in which an object is displayed on a display screen on which an image is displayed,
perform second extraction processing to extract a plurality of display candidate regions that are candidates for a region in which synthesized information to be synthesized with the image is displayed from regions other than the region extracted by the first extraction processing on the display screen,
perform selection processing to select an optimum one of the regions extracted by the second extraction processing as a region in which the synthesized information is displayed on the display screen, and
perform display processing to display the synthesized information in the region selected by the selection processing on the display screen.

2. The information presentation apparatus according to claim 1, wherein
the processor is configured to
select a region having a greatest area among the regions extracted by the second extraction processing as the region in which the synthesized information is displayed on the display screen in the selection processing.

3. The information presentation apparatus according to claim 1, wherein
the processor is configured to
extract regions, which are separated by a certain distance from the region in which the object is displayed on the display screen, from the regions other than the region extracted by the first extraction processing as the display candidate regions in the second extraction processing.

4. The information presentation apparatus according to claim 1, wherein
the processor is configured to
extract, when the region extracted by the first extraction processing in which the object is displayed is changed after the extraction of the plurality of display candidate regions, the plurality of display candidate regions again from regions other than the changed region on the display screen in the second extraction processing.

5. An information presentation method performed by an information presentation apparatus including a processor, the information presentation method comprising the steps of:
performing, by the processor, first extraction processing to extract a region in which an object is displayed on a display screen on which an image is displayed;
performing, by the processor, second extraction processing to extract a plurality of display candidate regions that are candidates for a region in which synthesized information to be synthesized with the image is displayed from regions other than the region extracted by the first extraction processing on the display screen;
performing, by the processor, selection processing to select an optimum one of the regions extracted by the second extraction processing as a region in which the synthesized information is displayed on the display screen; and
performing, by the processor, display processing to display the synthesized information in the region selected by the selection processing on the display screen.

6. The information presentation method according to claim 5 comprises,
selecting a region having a greatest area among the regions extracted by the second extraction processing as the region in which the synthesized information is displayed on the display screen in the selection processing.

7. The information presentation method according to claim 5 comprises
extracting regions, which are separated by a certain distance from the region in which the object is displayed on the display screen, from the regions other than the region extracted by the first extraction processing as the display candidate regions in the second extraction processing.

8. An information presentation processing program causing the processor to function as the respective processing of the information presentation apparatus according to claim 1.
